(19) United States
(12) Patent Application Publication
(10) Pub. No.: US 2004/0025442 A1
(43) Pub. Date: Feb. 12, 2004

(54) Composition for texturing process

(76) Inventors: Katsura Ito, Shiojiri-shi (JP); Jiro Yamada, Shiojiri-shi (JP); Kimihiro Hon, Nagoya-shi (JP); Megumi Kanda, Nagoya-shi (JP)

Correspondence Address: SUGHRUE MION, PLLC, 2100 PENNSYLVANIA AVENUE, N.W., WASHINGTON, DC, 20037, US

(21) Appl. No.: 10/312,834

(22) PCT Filed: Dec. 11, 2001
(86) PCT No.: PCT/JP01/10851

(30) Foreign Application Priority Data
Dec. 15, 2000 (JP) 2000-404282

(51) Int. Cl. C09K 3/14

(52) U.S. Cl. 51/307; 51/309

(57) ABSTRACT

A composition for use in texturing includes (i) microparticles or powder formed of at least one species selected from the group consisting of diamond, CBN, alumina and silicon carbide; (ii) at least one species selected from the group consisting of C2-C5 polyhydric alcohols, polycondensed products of the alcohols and alkylene glycol monoalkyl ethers represented by formula R₁O(CₙH₂ₙO)ₘH (wherein R₁ represents a C1-C4 linear or branched alkyl group, m is an integer of 1 to 3 and n is 2 or 3); and (iii) a C10-C22 fatty acid. When polishing a substrate using the composition, it is possible to form minute texturing lines, remove “polish lines” and “polish scratches” and minimize the mean surface roughness (Ra) of the undercoat layer of the substrate after texturing.

### CROSS REFERENCE TO RELATED APPLICATIONS

This application is an application filed under 35 U.S.C. § 111(a) claiming the benefit pursuant to 35 U.S.C. § 119(e)(1) of the filing date of Provisional Application Serial No. 60/269,849 filed Feb. 21, 2001 pursuant to 35 U.S.C. §111(b).

### TECHNICAL FIELD

The present invention relates to a composition for use in texturing for imparting texturing lines to a magnetic disk substrate; to a slurry containing the composition; and to a magnetic disk which has undergone texturing. More particularly, the invention relates to a composition for use in texturing, which composition is capable of rapidly forming minute texturing lines and minimizing the mean surface roughness (Ra) of the textured undercoat layer; to slurry containing the composition; and to a magnetic disk that has undergone texturing.

### BACKGROUND ART

In order to meet demand for increasing the recording density of magnetic disks, the distance between the magnetic disk surface and the magnetic head has been reduced to approximately 50 to 100 nm, for example. Thus, the magnetic disk surface must be as flat as possible. Such a high degree of flatness of the magnetic disk surface causes a problem; i.e., sticking of a magnetic head, which hinders the resumption of drive of the magnetic disk after stopping, making starting of a hard disk drive impossible. In order to prevent the aforementioned “sticking of a magnetic head,” until several years ago, the undercoat layer of a magnetic disk (a layer provided below the magnetic layer) has usually been subjected to texturing.

Texturing is a process in which the undercoat layer surface of a magnetic disk is scrubbed through sliding contact with an abrasive tape to which abrasive grains having a specific particle size adhere or a suspension of abrasive grains, to thereby form minute lines on the surface of the undercoat layer of the magnetic disk. Until several years ago, the thus-formed texturing lines were provided in order to prevent “sticking of a magnetic head,” and therefore, the texturing lines were required to satisfy certain conditions; i.e., the lines must have dimensions which are large enough to prevent the sticking but small enough to prevent collision against the floating magnetic head. In addition, the texturing lines were required to be in a sufficiently uniform state.

Conventionally, as a composition for use in texturing for providing texturing lines, there has been employed slurry prepared by mixing abrasive grains formed of diamond or alumina with a polishing liquid.

For example, JP-A HEI 6-33042 discloses a polishing composition for texturing a memory hard disk, which composition is obtained by dispersing abrasive grains of diamond, silicon carbide or aluminum oxide in a dispersion medium of C2-C5 dihydric alcohol, polycondensed ethylene glycol or polycondensed propylene glycol. JP-A HEI 8-287456 discloses a composition for texturing a magnetic disk substrate, which composition contains microparticles or powder of diamond or a similar substance, alkylene glycol monoalkyl ether and a fatty acid or a metal salt thereof.

In recent years, however, “sticking of a magnetic head” is prevented by forming, in the inner zone of a magnetic disk, bumps through laser processing (called “laser bumps” in the art) and by placing the magnetic head on the bumps during the stationary state of the magnetic disk. Thus, at present, texturing is performed for a purpose other than prevention of “sticking of a magnetic head.”

Specifically, minute texturing lines are formed in order to uniformly arrange the crystal orientation of particles contained in a magnetic layer to be formed on the textured magnetic disk surface, thereby effectively performing magnetic recording. Thus, instead of texturing lines of the dimension of some μm that was previously employed, 10 to 30 texturing lines are provided per μm.

In another example, texturing is performed in order to remove “polish lines” and “polish scratches” generated in the undercoat layer of the magnetic disk during the course of a substrate polishing process performed prior to texturing. These “polish lines” and “polish scratches” cause errors during write-in and read-out of records by means of magnetic particles, thus inhibiting enhancement of the recording density of the magnetic disk.

In yet another example, texturing is performed in order to reduce the mean surface roughness (Ra) of the undercoat layer after texturing to thereby minimize the flying height of the magnetic disk.

However, the polishing composition for texturing and the composition for texturing disclosed in the prior art publications are provided in order to prevent “sticking of a magnetic head,” and therefore, cannot simultaneously attain formation of minute texturing lines, removal of “polish lines” and “polish scratches” and minimization of the mean surface roughness (Ra) of the undercoat layer after texturing, which are to be attained through a current texturing process.

In order to enhance the recording density of a magnetic disk, it is required to reduce the surface roughness of the textured undercoat layer of the magnetic disk (a layer provided below the magnetic layer), thereby making the flying height of the magnetic head smaller than the conventional height, to form minute texturing lines in a circumferential direction of the disk, thereby attaining effective magnetic recording and to remove “polish lines” and “polish scratches” generated in the undercoat layer of the magnetic disk during the course of a substrate polishing process performed prior to texturing.

Reducing the surface roughness of the textured undercoat layer and forming minute texturing lines requires use of microparticles or powder. However, since a decrease in particle size generally causes a decrease in processing rate, “polish lines” and “polish scratches” are difficult to remove through a short-duration texturing process.

The present invention has been accomplished so as to solve the aforementioned problems. Thus, an object of the present invention is to provide a composition for use in texturing, which composition minimizes the mean surface roughness (Ra) of the undercoat layer of a magnetic disk after texturing, forms minute texturing lines and removes, through texturing at a high processing rate, “polish lines” and “polish scratches” generated during the course of a substrate polishing process.

### DISCLOSURE OF THE INVENTION

The present invention provides a composition for use in texturing, which comprises:

(i) microparticles or powder formed of at least one species selected from the group consisting of diamond, CBN, alumina and silicon carbide;

(ii) at least one species selected from the group consisting of C2-C5 polyhydric alcohols, polycondensed products of the alcohols and alkylene glycol monoalkyl ethers represented by formula R₁O(CₙH₂ₙO)ₘH (wherein R₁ represents a C1-C4 linear or branched alkyl group, m is an integer of 1 to 3 and n is 2 or 3); and

(iii) a C10-C22 fatty acid.

The aforementioned microparticles or powder may have an average particle size of 0.01 to 1 μm. The amount of the aforementioned microparticles or powder contained in the composition for use in texturing may be 0.001 to 5 mass %.

The amount of the aforementioned C2-C5 polyhydric alcohols, polycondensed products of the alcohols and/or alkylene glycol monoalkyl ethers contained in the composition for use in texturing contains may be 1 to 50 mass %.

The aforementioned fatty acid may be lauric acid or oleic acid. The amount of the fatty acid contained in the composition for use in texturing may be 0.01 to 5 mass %.

The composition of the present invention for use in texturing may further contain an organic amine compound. The amount of the organic amine compound contained in the composition for use in texturing may be 0.01 to 20 mass %.

The composition of the present invention for use in texturing may further contain a surfactant. The surfactant may be at least one species selected from the group consisting of anionic surfactants and nonionic surfactants. The total amount of the surfactants contained in the composition for use in texturing may be 0.01 to 10 mass %.

The present invention further provides slurry that is formed by use of the aforementioned composition for use in texturing. The solvent for the slurry may be at least one species selected from the group consisting of water, C1-C10 monohydric alcohols, glycols, C3-C10 polyhydric alcohols, dimethyl sulfoxide, dimethylformamide, tetrahydrofuran and dioxane.

The present invention further provides a magnetic disk that has undergone texturing using the aforementioned composition for texturing.

When texturing a magnetic disk substrate, for example, using the composition of the present invention, approximately 20 to 30 minute texturing lines can be formed per μm at a high processing rate and “polish lines” and “polish scratches” existing in the undercoat layer before texturing can be removed through a short-duration texturing process, leading to remarkable enhancement of productivity of high-quality magnetic disks.

### BRIEF DESCRIPTION OF THE DRAWINGS

FIG. 1 is a schematic cross-sectional view showing an example constitution of a magnetic disk substrate on which a magnetic layer has not yet been formed.

FIG. 2(a) is a schematic front view showing a mode for subjecting a magnetic disk substrate to texturing.

FIG. 2(b) is a schematic perspective view showing the mode for subjecting the magnetic disk substrate to texturing.

### MODES FOR CARRYING OUT THE INVENTION

The composition for use in texturing according to the present invention comprises (i) microparticles or powder formed of at least one species selected from the group consisting of diamond, CBN, alumina and silicon carbide; (ii) at least one species selected from the group consisting of C2-C5 polyhydric alcohols, polycondensed products of the alcohols and alkylene glycol monoalkyl ethers represented by formula R₁O(CₙH₂ₙO)ₘH (wherein R₁ represents a C1-C4 linear or branched alkyl group, m is an integer of 1 to 3 and n is 2 or 3); and (C) a C10-C22 fatty acid.

The diamond used in the form of microparticles or powder in the present invention is diamond which occurs naturally or is industrially synthesized and which has a particle size corresponding to that of coarse powder or micropowder of abrasive or abrasive grains prescribed in accordance with JIS R6001-1987. However, other than these particles or powder, there may also be used microparticles or powder exhibiting a particular particle size distribution.

The CBN used in the form of microparticles or powder in the present invention is industrially synthesized CBN which has the aforementioned particle size prescribed in accordance with JIS R6001-1937. However, other than these particles or powder, there may be also used microparticles or powder exhibiting a particular particle size distribution.

The alumina or silicon carbide used in the form of microparticles or powder in the present invention is an artificial abrasive prescribed in accordance with JIS R6111-1987 or a similar material, and the microparticles or powder of alumina or a similar substance has a particle size corresponding to that of coarse powder or micropowder of abrasive or abrasive grains prescribed in accordance with JIS R6001-1987. In addition, alumina powder and silicon carbide powder for sintering are also included within the scope of the present invention.

Preferably, the aforementioned microparticles or powder has a maximum particle size of 5 μm or less, more preferably 3 μm or less. When the maximum particle size is in excess of 5 μm, the texturing lines to be formed tend to have an excessive width, leading to difficulty in the formation of minute texturing lines.

The aforementioned microparticles or powder has an average particle size of 0.01 to 1 μm, preferably 0.03 to 0.5 μm. When the average particle size is in excess of 1 μm, the texturing lines to be formed tend to have an excessive width, leading to difficulty in the formation of minute texturing lines, whereas when the size is less than 0.01 μm, polishing performance decreases, leading to difficulty in the removal of “polish lines” and “polish scratches” through texturing at a high polishing rate.

The amount of the aforementioned microparticles or powder contained in the composition for use in texturing is preferably 0.001 to 5 mass %, more preferably 0.005 to 1 mass %. When the amount of the microparticles or similar substance is less than 0.001 mass %, texturing performance drastically decreases, sometimes leading to difficulty in the removal of “polish lines” and “polish scratches.” When the amount of microparticles or similar material is elevated to more than 5 mass %, further enhancement in texturing efficiency commensurate with the amount of addition is not recognizable and is thus proven to be economically disadvantageous. Thus, the amount is preferably 5 mass % or less.

When two or more species of microparticles or powder are used in combination, these species are preferably mixed so as to attain the amount falling within the aforementioned range.

As mentioned above, the composition of the present invention contains at least one species selected from the group consisting of specific alkylene glycol monoalkyl ethers, polyhydric alcohols, and polycondensed products of the alcohols. Examples of the specific alkylene glycol monoalkyl ethers include those represented by formula R₁O(CₙH₂ₙO)ₘH wherein R₁ represents a C1-C4 linear or branched alkyl group, m is an integer of 1 to 3, and n is an integer of 2 or 3.

No particular limitation is imposed on the alkylene glycol monoalkyl ethers which are used in the present invention, but specific examples of preferable ether include ethylene glycol monomethyl ether (CH₃OCH₂CH₂OH), ethylene glycol monoethyl ether (C₂H₅OCH₂CH₂OH), ethylene glycol monobutyl ether (C₄H₉OCH₂CH₂OH), diethylene glycol monomethyl ether (CH₃(OCH₂CH₂)₂OH) diethylene glycol monoethyl ether (C₂H₅(OCH₂CH₂)₂OH), diethylene glycol monobutyl ether (C₄H₉(OCH₂CH₂)₂OH) propylene glycol monomethyl ether (CH₃OCH(CH₃)CH₂OH), propylene glycol monoethyl ether (C₂H₅OCH(CH₃)CH₂OH), propylene glycol monobutyl ether (C₄H₉OCH(CH₃)CH₂OH) dipropylene glycol monomethyl ether (CH₃ (OCH(CH₃) CH₂)₂OH), dipropylene glycol monoethyl ether (C₂H₅ (OCH(CH₃)CH₂)₂OH), triethylene glycol monomethyl ether (CH₃(OCH₂CH₂)₃OH), triethylene glycol monoethyl ether (C₂H₅(OCH₂CH₂)₃OH) and tripropylene glycol monomethyl ether (CH₃ (OCH₂CH₂CH₂)₃OH).

No particular limitation is imposed on the C2-C5 polyhydric alcohols and polycondensates thereof which are used in the present invention, but specific examples of preferable alcohol and its polycondensate include ethylene glycol (HOCH₂CH₂OH), propylene glycol (CH₃CH(OH)CH₂OH), 1,3-propanediol (HO(CH₂)₃OH), 1,2-butanediol (HOCH₂CH(OH)CH₂CH₃), 1,3-butanediol (HOCH₂CH₂CH(OH)CH₃), 1,4-butanediol (HO(CH₂)₄OH), 2,3-butanediol (CH₃CH(OH)CH(OH)CH₃), 1,2-pentanediol (HOCH₂CH(OH)CH₂CH₂CH₃), 1,3-pentanediol (HOCH₂CH₂CH(OH)CH₂CH₃), 1,4-pentanediol (HOCH₂CH₂CH₂CH(OH)CH₃), 1,5-pentanediol (HO(CH₂)₅OH), 2,3-pentanediol (CH₃CH(OH)CH(OH)CH₂CH₃), 2,4-pentanediol (CH₃CH(OH)CH₂CH(OH)CH₃), 2-methyl-1,2-propanediol (HOCH₂C(CH₃)(OH)CH₃), 2-methyl-1,3-propanediol (HOCH₂CH(CH₃)CH₂OH), 2-methyl-1,2-butanediol (HOCH₂C(CH₃)(OH)CH₂CH₃), 2-methyl-1,3-butanediol (HOCH₂CH(CH₃)CH(OH)CH₃), 2-methyl-1,4-butanediol (HOCH₂CH(CH₃)CH₂CH₂OH), 2-methyl-2,3-butanediol (CH₃C(CH₃)(OH)CH(OH)CH₃), 2-methyl-2,4-butanediol (CH₃C(CH₃)(OH)CH₃CH₂OH), 2-methyl-3,4-butanediol (CH₃CH(CH₃)CH(OH)CH₂OH), diethylene glycol (HOCH₂CH₂OCH₂CH₂OH), triethylene glycol (HOCH₂CH₂OCH₂CH₂OCH₂CH₂OH), polyethylene glycol (HO(CH₂CH₂O)_{q}CH₂CH₂OH), dipropylene glycol (HOCH(CH₃)CH₂OCH₂CH(CH₃)OH), tripropylene glycol (HOCH(CH₃)CH₂OCH₂CH(CH₃)OCH₂CH(CH₃)OH), polypropylene glycol (HOCH(CH₃)CH₂O(CH₂CH(CH₃)O)_{q}CH₂CH(CH₃)OH) and glycerin (HOCH₂CH(OH)CH₂OH). These alcohols may be used singly or in combination of two or more species. In the aforementioned formulae representing polyethylene glycol and polypropylene glycol, the suffix “q” represents an integer of 4 or more.

The composition of the present invention for use in texturing contains the aforementioned specific alkylene glycol ether and the aforementioned C2-C5 polyhydric alcohol or a polycondensate thereof in a total amount of 1 to 50 mass %, preferably 3 to 30 mass %.

When the amount is less than 1 mass %, the below-mentioned fatty acid is difficult to dissolve completely, and the processing rate decreases, leading to difficulty in the satisfactory removal of “polish lines” and “polish scratches” through a short-duration texturing process. In contrast, when the amount is in excess of 50 mass %, the viscosity of the composition for use in texturing increases, leading to difficulty in the formation of uniform, minute texturing lines and minimization of the mean surface roughness (Ra) of the undercoat layer after texturing.

No particular limitation is imposed on the fatty acid that is used in the present invention, but C10-C22 saturated or mono-, di- or tri-unsaturated fatty acids can be used. Specific examples thereof include capric acid, lauric acid, myristic acid, palmitic acid, stearic acid, behenic acid, oleic acid, linolic acid and linolenic acid. Note that metal salts of these fatty acids are not included in the fatty acid according to the present invention.

In the present invention, the aforementioned fatty acids may be used singly or in combination. Although fatty acids other than C10-C22 fatty acids may also be used in combination, any of the C10-C22 fatty acids must be predominantly used in order to fully attain the object of the present invention.

The composition for use in texturing contains the fatty acids in a total amount of 0.01 to 20 mass %, preferably 0.05 to 5 mass %. When the amount is less than 0.01 mass %, the processing rate decreases, sometimes leading to difficulty in the satisfactory removal of “polish lines” and “polish scratches” through a short-duration texturing process and in the formation of minute texturing lines. In contrast, when the amount is in excess of 5 mass %, further effect commensurate with the addition is not confirmed, and the composition of the present invention is difficult to form a homogeneous dispersion system. Thus, the amount is preferably 5 mass % or less.

Preferably, the composition of the present invention for use in texturing further contains an organic amine compound. No particular limitation is imposed on the amine compound, but specific examples of the organic amine compounds which are preferably used in the present invention include methylamine (CH₃NH₂), ethylamine (CH₃CH₂NH₂), propylamine (CH₃(CH₂)₂NH₂), isopropylamine ((CH₃)₂CHNH₂), butylamine (CH₃(CH₂)₃NH₂), amylamine (CH₃(CH₂)₄NH₂), hexylamine (CH₃(CH₂)₅NH₂), heptylamine (CH₃(CH₂)₆NH₂), octylamine (CH₃(CH₂)₇NH₂), nonylamine. (CH₃(CH₂)₈NH₂), decylamine (CH₃(CH₂)₉NH₂), undecylamine (CH₃(CH₂)₁₀NH₂) dodecylamine (CH₃(CH₂)₁₁NH₂), tridecylamine (CH₃(CH₂)₁₂NH₂), tetradecylamine (CH₃(CH₂)₁₃NH₂), pentadecylamine (CH₃(CH₂)₁₄NH₂), cetylamine (CH₃(CH₂)₁₅NH₂) dimethylamine ((CH₃)₂NH), diethylamine ((C₂H₅)₂NH) dipropylamine ((n-C₃H₇)₂NH), diisopropylamine ((i-C₃H₇)₂NH), dibutylamine ((n-C₄H₉)₂NH), diamylamine ((n-C₅H₁₁)₂NH), trimethylamine ((CH₃)₃N), triethylamine ((C₂H₅)₃N), tripropylamine. ((n-C₃H₇)₃N), tributylamine ((n-C₄H₉)₃N), triamylamine ((n-C₅H₁₁)₃N), allylamine (CH₂═CHCH₂NH₂), diallylamine ((CH₂═CHCH₂)₂NH), triallylamine ((CH₂═CHCH₂)₃N), aniline (C₆H₅NH₂), methylaniline (C₆H₅NHCH₃), dimethylaniline (C₆H₅N(CH₃)₂), ethylaniline (C₆H₅NHC₂H₅), diethylaniline (C₆H₅N(C₂H₅)₂), toluidine (C₆H₄(CH₃)(NH₂)), benzylamine (C₆H₅CH₂NH₂), dibenzylamine ((C₆H₅CH₂)₂NH), tribenzylamine ((C₆H₅CH₂)₃N), diphenylamine ((C₆H₅)₂NH), triphenylamine ((C₆H₅)₃N), naphthylamine (C₁₀H₇NH₂), ethanolamine (HOCH₂CH₂NH₂), propanolamine (HOCH₂CH₂CH₂NH₂), butanolamine (HOCH₂CH₂CH₂CH₂NH₂), diethanolamine ((HOCH₂CH₂)₂NH), dipropanolamine ((HOCH₂CH₂CH₂)₂NH), dibutanolamine ((HOCH₂CH₂CH₂CH₂)₂NH), triethanolamine ((HOCH₂CH₂)₃N), tripropanolamine ((HOCH₂CH₂CH₂)₃N) and tributanolamine ((HOCH₂CH₂CH₂CH₂)₃N) These compounds may be used singly or in combination of two or more species.

The composition for use in texturing contains the organic amine compounds in a total amount of 0.01 to 20 mass %, preferably. 0.05 to. 10 mass %. When the amount is less than 0.01 mass %, the processing rate decreases, leading to difficulty in the satisfactory removal of “polish lines” and “polish scratches” through a short-duration texturing process. In contrast, when the amount is in excess of 20 mass %, further effect commensurate with the addition is not confirmed. Thus, the amount is preferably 20 mass % or less.

The microparticles or powder of diamond, CBN, alumina or silicon carbide, one of alkyl ether, alcohol and its polycondensed product, and fatty acid are mixed in respectively predetermined amounts and sufficiently stirred to produce a composition for use in texturing according to the present invention.

Preferably, the composition of the present invention for use in texturing further contains a surfactant. In order to fully attain the object of the present invention, in the composition of the present invention for use in texturing, components other than microparticles or powder of diamond or a similar substance desirably forms a homogeneous medium, at least the mixture being emulsion. Therefore, a surfactant is desirably added so as to form a homogeneous medium or an emulsion.

Examples of the surfactants used in the present invention include anionic surfactants, cationic surfactants, ampholytic surfactants and nonionic surfactants. Although any of these surfactants can exert satisfactory performance, nonionic surfactants are particularly preferred in the present invention.

Examples of the anionic surfactants which are used in accordance with need include known carboxylate salts (e.g., soap, N-acylamino acid salts, alkyl ether carboxylate, acylated peptides); sulfonate salts (e.g., alkanesulfonate (including alkylbenzenesulfonate), alkylnaphthalenesulfonate, sulfosuccinate, α-olefinsulfonate, N-acylsulfonate); sulfate ester salts (e.g., sulfonated oil, alkyl sulfate, alkyl ether sulfate, alkyl allyl ether sulfate, alkylamide sulfate); and phosphate ester salts (e.g., alkyl phosphate, alkyl ether phosphate, alkyl allyl ether phosphate). These salts may have a low molecular weight or a high molecular weight. The term “salt” used herein refers to at least one salt selected from among Li salts, Na salts, K salts, Rb salts, Cs salts and ammonium salts.

For example, the soap is a C12-C18 fatty acid salt generally having a fatty acid moiety derived from lauric acid, myristic acid, palmitic acid, stearic acid, etc, examples of the N-acylamino acid salts include C12-C18 N-acyl-N-methylglycine salts and N-acylglutamate salts, examples of the alkyl ether carboxylate salts include. C6-C18 compounds and examples of the acylated peptides include C12-C18 compounds. Examples of the sulfonate salts include the aforementioned C6-C18 compounds. For example, when the corresponding acid is an alkanesulfonic acid, examples of the acid include laurylsulfonic acid, dioctylsuccinosulfonic acid, benzenesulfonic acid, dodecylbenzenesulfonic acid, etc. Examples of the sulfate ester salts include the aforementioned C6-C18 compounds. For example, when the corresponding acid is an alkyl sulfuric acid, examples of the acid include lauryl sulfuric acid, dioctylsuccinosulfuric acid, myristyl sulfuric acid and stearyl sulfuric acid. Examples of the phosphate ester salts include the aforementioned C8-C18 compounds. Examples of the nonionic surfactants include polyoxyethylene alkyl phenol ethers, polyoxyethylene alkyl ethers and polyoxyethylene fatty acid esters. In addition to the aforementioned anionic surfactants and nonionic surfactants, known fluorine-containing surfactants may also be used.

The composition for use in texturing contains the surfactants in amounts of 0.01 to 10 mass %, preferably 0.05 to 5 mass %. When the amounts are less than 0.01 mass %, the formation of minute texturing lines is sometimes difficult, whereas when the amounts are in excess of 10 mass %, the processing rate decreases due to slippage of microparticles or powder of diamond or a similar substance, leading to difficulty in the satisfactory removal of “polish lines” and “polish scratches” through a short-duration texturing process.

In order to prevent sedimentation of the slurry or enhance stability of the slurry, the abrasive slurry composition of the present invention may further contain, in addition to the aforementioned surfactants, additives such as polymer dispersants (e.g., tripolyphosphate), phosphate salts (e.g., hexametaphosphate), cellulose ethers (e.g., methyl cellulose and carboxymethyl cellulose) and water-soluble polymers (e.g., polyvinyl alcohol). Generally, these additives are added to the abrasive preferably in amounts of 0.05 to 20 mass %, particularly preferably 0.1 to 10 mass %.

By use of the composition of the present invention for use in texturing, uniform and minute texturing lines can be formed in the undercoat layer of a magnetic disk substrate, and “polish lines” and “polish scratches” generated due to a substrate polishing process can be removed through texturing at a high processing rate. Particularly, when the undercoat layer of the magnetic disk substrate is formed of Ni—P or glass, the aforementioned effects can be fully attained.

The slurry of the present invention may be formed exclusively of the composition for use in texturing or diluted with a suitable solvent to appropriately adjust the concentration thereof. No particular limitation is imposed on the method for producing the slurry, but the slurry can be produced by appropriately adopting the dry-milling process, wet-milling process or other processes used in the art.

As the solvent for the slurry, there can be used at least one member selected from the group consisting of water; C1-C10 monohydric alcohols such as methanol, ethanol, propanol, isopropanol and butanol; dimethyl sulfoxide (DMSO), dimethylformamide (DMF); tetrahydrofuran; and dioxane. Of these, water and alcohols are preferably used.

The method of texturing will next be described with reference to the drawings. However, the present invention is not limited thereto.

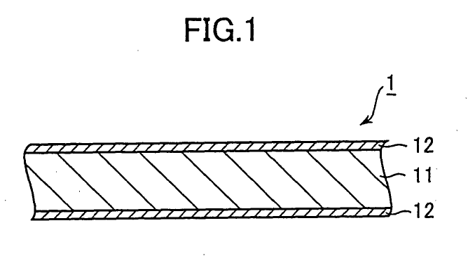

FIG. 1 is a schematic cross-sectional view showing an example of the constitution of a magnetic disk substrate on which a magnetic layer has not yet been formed. A magnetic disk substrate 1 comprises a base substrate 11 formed of Al alloy or similar material and an undercoat layer 12 of Ni—P formed on the both surfaces of the base substrate 11. The surface of the undercoat layer 12 has undergone texturing to thereby be imparted with texturing lines, and a magnetic layer is formed on the thus-processed surface. In the case in which the base substrate 11 is formed of glass, no undercoat layer 12 is provided, and the glass surface is subjected to texturing to thereby provide texturing lines. A magnetic layer can be formed directly on the textured glass surface or on the textured surface of the undercoat layer formed on the glass surface. Hereunder, the method for texture-processing an undercoat layer will next be described. Note that the method can also be applied to texturing carried out on a glass surface.

Prior to texturing, the surface of the undercoat layer 12 is subjected to mirror-polishing to thereby adjust the mean surface roughness (Ra) to preferably 0.5 nm or less.

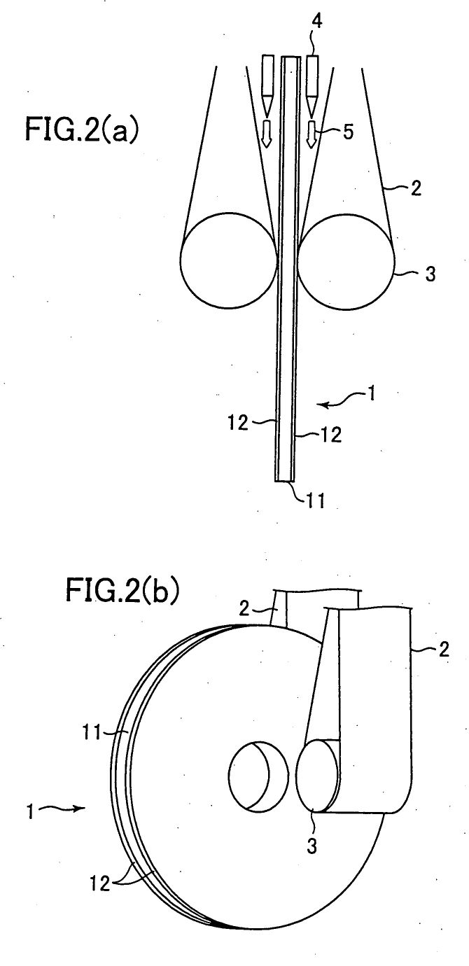

FIG. 2(a) is a schematic cross-sectional view showing a mode for subjecting a magnetic disk substrate 1 to texturing, and FIG. 2(b) is a perspective view showing the same mode. A tape 2 is pressed against each undercoat layer surface of the magnetic disk substrate 1 by means of a roller 3 to contact the magnetic disk surface. Slurry 5 of the composition for use in texturing is fed to the tape surface and/or the magnetic disk surface from a slurry-feeding apparatus 4 provided above the tape 2. The magnetic disk substrate 1 is rotated while each tape 2 remains pressed to thereby form texturing lines on each undercoat layer of the magnetic disk. In FIG. 2(b), the tape 2 can be moved in a direction that is the same as or opposite that of rotation of the magnetic disk substrate 1, with the rotation of the roller 3 modified. In other words, the contact portion of the tape on the magnetic disk substrate slides in the circumferential direction, resulting in slide contact of the substrate surface with abrasive grains adhering on the tape to thereby form bump-like texturing lines. The feeding manner of the slurry-feeding apparatus 4 may be continuous, intermittent or discontinuous. No particular limitation is imposed on the method of pressing the tape 2, and the tape may be pressed by the weight of the roller itself or may be pressed by means of external pressure. In the latter case, the external pressure is appropriately selected from the range of 0.1 to 20 kg, preferably 0.5 to 10 kg.

Examples of the material of the tape for sliding contact that can be used in the present invention include woven fabric tape made of nylon fiber, polyester fiber, etc.; non-woven fabric tape; flocked fabric tape; and polyurethane foam tape.

In texturing, the magnetic disk substrate 1 is rotated at 50 to 2,000 rpm, preferably 100 to 1,000 rpm. When the rotation speed is slower than 50 rpm, the processing rate decreases, leading to difficulty in full removal of “polish lines” and “polish scratches” through a short-duration texturing process, whereas when the speed is faster than 2,000 rpm, the composition for use in texturing becomes unable to remain on the surface of the undercoat layer and is dispersed to the outside of the surface, causing contamination of the texturing apparatus, which is not practical.

On the thus-textured undercoat layer, an intermediate layer and a magnetic layer are formed to thereby provide a magnetic disk. Since the intermediate layer and the magnetic layer are formed to small thickness (generally 0.05 to 0.15 μm) through plating, sputtering, vapor-deposition or other techniques practiced in the art, lines substantially similar to the texturing lines emerge on the surface of the magnetic layer. The magnetic layer may be further coated with a protective layer, which is formed to a small thickness (generally 0.01 to 0.03 μm) from a material of high lubricity, such as carbon, through sputtering or a similar method. Thus, the lines substantially similar to the texturing lines also emerge on the surface of the protective layer.

The present invention will next be described in detail by way of examples, which should not be construed as limiting the invention thereto. In the following Examples, diethylene glycol monobutyl ether was used as the alkylene glycol monoalkyl ether; ethylene glycol was used as the C2-C5 polyhydric alcohol or its polycondensate; and lauric acid was used as the fatty acid. However, the present invention is not limited to use of these compounds.

### EXAMPLES 1 TO 11

An aluminum substrate for a magnetic disk (3.5 inches) was plated with Ni—P for serving as an undercoat layer. The plated substrate was mirror-polished in advance. The polished substrate was placed in a texturing machine (type EDC-1800A, product of Exclusive Design, USA) as shown in FIG. 2.

In each Example, the disk was rotated at 200 rpm, while slurry formed of each composition for use in texturing having a composition shown in Table 1 was fed from a slurry-feeding apparatus to the upper side of a portion to be polish-processed by means of a tape for sliding contact. The feeding speed was 10 ml/min, and the slurry was continuously fed during texturing.

The roller was rotated such that the tape ran at 5 cm/min in the direction identical to the rotation direction of the magnetic disk substrate. The pressure of the roller during texturing was 2.0 kg, and the texturing time was 30 seconds.

After texturing was completed, each magnetic disk substrate was evaluated in the following manner.

Evaluation methods:

(1) Number of Texturing Lines (Line Density)

By use of an interatomic force microscope (Nanoscope-III, product of Digital Instruments, USA), the number of texturing lines formed on the magnetic disk surface (undercoat layer) was counted within an area (1 μm×1 μm) through visual observation.

(2) Processing Rate

The weight of each magnetic disk was measured before and after texturing to thereby calculate the weight loss after texturing. The weight loss was divided by the processing time to thereby obtain the weight loss per minute serving as the processing rate.

(3) Mean Surface Roughness (Ra)

By use of a contact profile meter (Talystep, product of Taylor Hobson, UK), the mean surface roughness of each disk substrate surface (undercoat layer) after completion of the process was measured.

The obtained evaluation results are shown in Table 1.

### COMPARATIVE EXAMPLES 1 TO 8

The procedure of Example 1 was repeated, except that compositions for use in texturing having compositions shown in Table 2 were used, to thereby perform texturing. In a manner similar to that of Example 1, magnetic disk substrates were evaluated after completion of texturing. The evaluation results are shown in Table 2.

TABLE 1

| | Microparticles | | | | | | | | | | | Evaluation results | | |
|---|---|---|---|---|---|---|---|---|---|---|---|---|---|---|
| | or powder (i) | | | Org. solvent | | | | | | | | | Process- | |
| | | Av. | | (ii) | | Fatty acid (iii) | | Org. amine | | Surfactant | | Line | ing | |
| | | size | Amount | | Amount | | Amount | | Amount | | Amount | density | rate | Ra |
| | Type | (μm) | (wt %) | Type | (wt %) | Type | (wt %) | Type | (wt %) | Type | (wt %) | (No/μm) | (mg/min) | (Å) |
| Ex. 1 | Diamond | 0.2 | 0.1 | EG | 10 | Lauric | 0.25 | TEA | 0.5 | A | 0.5 | 25 | 7.5 | 6.0 |
| Ex. 2 | Alumina | 0.2 | 0.1 | EG | 10 | Lauric | 0.25 | TEA | 0.5 | A | 0.5 | 20 | 6.0 | 6.5 |
| Ex. 3 | SiC | 0.4 | 0.1 | EG | 10 | Lauric | 0.25 | TEA | 0.5 | A | 0.5 | 16 | 9.0 | 7.5 |
| Ex. 4 | Diamond | 0.2 | 0.1 | BC | 10 | Lauric | 0.25 | TEA | 0.5 | A | 0.5 | 25 | 7.5 | 6.0 |
| Ex. 5 | Diamond | 0.2 | 0.1 | EG | 10 | Oleic | 0.25 | TEA | 0.5 | A | 0.5 | 25 | 7.5 | 6.0 |
| Ex. 6 | Diamond | 0.2 | 0.1 | EG | 10 | Palmitic | 0.25 | TEA | 0.5 | A | 0.5 | 25 | 6.5 | 6.0 |
| Ex. 7 | Diamond | 0.2 | 0.1 | EG | 10 | Lauric | 0.25 | *1) | 0.5 | A | 0.5 | 25 | 7.5 | 6.0 |
| Ex. 8 | Diamond | 0.2 | 0.1 | EG | 10 | Lauric | 0.25 | TEA | 0.5 | B | 0.5 | 25 | 7.5 | 6.0 |
| Ex. 9 | Diamond | 0.2 | 0.1 | EG | 10 | Lauric | 0.25 | None | 0 | A | 0.5 | 25 | 6.5 | 6.0 |
| Ex. 10 | Diamond | 0.2 | 0.1 | EG | 10 | Lauric | 0.25 | TEA | 0.5 | None | 0 | 20 | 7.5 | 6.5 |
| Ex. 11 | Diamond | 0.2 | 0.1 | BC | 10 | Lauric | 0.25 | None | 0 | None | 0 | 22 | 3.7 | 6.6 |

*1) Propanolamine

TABLE 2

| | Microparticles | | | | | | | | | | | Evaluation results | | |
|---|---|---|---|---|---|---|---|---|---|---|---|---|---|---|
| | or powder (i) | | | Org. solvent | | | | | | | | | Process- | |
| | | Av. | | (ii) | | Fatty acid (iii) | | Org. amine | | Surfactant | | Line | ing | |
| | | size | Amount | | Amount | | Amount | | Amount | | Amount | density | rate | Ra |
| | Type | (μm) | (wt %) | Type | (wt %) | Type | (wt %) | Type | (wt %) | Type | (wt %) | (No/μm) | (mg/min) | (Å) |
| Comp. | Diamond | 0.2 | 0.1 | EG | 10 | None | 0 | None | 0 | None | 0 | 12 | 2.0 | 9.0 |
| Ex. 1 | | | | | | | | | | | | | | |
| Comp. | Diamond | 0.2 | 0.1 | EG | 10 | Na | 0.25 | TEA | 0.5 | A | 0.5 | 25 | 3.5 | 6.0 |
| Ex. 2 | | | | | | laurate | | | | | | | | |
| Comp. | Alumina | 0.2 | 0.1 | EG | 10 | Na | 0.25 | TEA | 0.5 | A | 0.5 | 20 | 3.0 | 6.5 |
| Ex. 3 | | | | | | laurate | | | | | | | | |
| Comp. | SiC | 0.4 | 0.1 | EG | 10 | Na | 0.25 | TEA | 0.5 | A | 0.5 | 16 | 4.5 | 7.5 |
| Ex. 4 | | | | | | laurate | | | | | | | | |
| Comp. | Diamond | 0.2 | 0.1 | EG | 10 | None | 0 | TEA | 0.5 | A | 0.5 | 15 | 3.0 | 8.0 |
| Ex. 5 | | | | | | | | | | | | | | |
| Comp. | Diamond | 0.2 | 0.1 | None | 0 | Lauric | 0.25 | TEA | 0.5 | A | 0.5 | 25 | 3.0 | 6.0 |
| Ex. 6 | | | | | | acid | | | | | | | | |
| Comp. | Diamond | 0.2 | 0.1 | None | 0 | None | 0 | TEA | 0.5 | A | 0.5 | 15 | 2.0 | 8.0 |
| Ex.7 | | | | | | | | | | | | | | |
| Comp. | Diamond | 0.2 | 0.1 | EG | 99.9 | None | 0 | None | 0 | None | 0 | 15 | 2.1 | 5.8 |
| Ex. 8 | | | | | | | | | | | | | | |

*In Tables, EG: ethylene glycol, TEA: triethanolamine, BC: diethylene glycol monobutyl ether, Na laurate: lauric acid sodium salt, surfactant A: polyoxyethyelene derivative, surfactant B: polyoxyethylene sorbitan monolaurate

As is clear from Table 1, in Examples 1 to 11, formation of minute texturing lines and high processing rate can be attained and the mean surface roughness of the undercoat layer surface can be minimized.

In contrast, in Comparative Examples 1 to 8 shown in Table 2, formation of minute texturing lines, removal of “polish lines” and “polish scratches” and minimization of the mean surface roughness (Ra) of the undercoat layer after completion of texturing cannot be attained simultaneously.

### INDUSTRIAL APPLICABILITY

By use of the composition of the present invention for use in texturing, approximately 20 to 30 minute texturing lines can be formed per μm on a magnetic disk substrate, for example, through texturing at a high processing rate which conventional compositions for use in texturing have never been attained. In addition, the mean surface roughness (Ra) of the undercoat layer can be minimized after completion of texturing. Thus, “polish lines” and “polish scratches” existing in the undercoat layer before texturing can be removed through a short-duration texturing process, leading to remarkable enhancement of productivity of magnetic disks.

1. A composition for use in texturing, which comprises:
(i) microparticles or powder formed of at least one species selected from the group consisting of diamond, CBN, alumina and silicon carbide;
(ii) at least one species selected from the group consisting of C2-C5 polyhydric alcohols, polycondensed products of the alcohols and alkylene glycol monoalkyl ethers represented by formula R₁O(CₙH₂ₙO)ₘH (wherein R₁ represents a C1-C4 linear or branched alkyl group, m is an integer of 1 to 3 and n is 2 or 3); and
(iii) a C10-C22 fatty acid.

2. The composition according to claim 1, wherein said microparticles or powder has an average particle size of 0.01 to 1 μm.

3. The composition according to claim 1 or claim 2, wherein an amount of said micropa1rticles or powder is 0.001 to 5 mass %.

4. The composition according to claim 1, wherein a total amount of said at least one species is 1 to 50 mass %.

5. The composition according to claim 1, wherein said fatty acid is lauric acid or oleic acid.

6. The composition according to claim 1 or claim 5, wherein an amount of said fatty acid is 0.01 to 5 mass %.

7. The composition according to claim 1, wherein it further contains an organic amine compound.

8. The composition according to claim 7, wherein an amount of said organic amine compound is 0.01 to 20 mass %.

9. The composition according to claim 1, wherein it further contains a surfactant.

10. The composition according to claim 9 wherein said surfactant is at least one species selected from the group consisting of anionic surfactants and nonionic surfactants.

11. The composition according to claim 9 or claim 10, wherein a total amount of said surfactant is 0.01 to 10 mass %.

12. Slurry that is formed by use of said composition according to any one of claims 1 to 11.

13. The slurry according to claim 12, wherein a solvent for the slurry is at least one species selected from the group consisting of water, C1-C10 monohydric alcohols, glycols, C3-C10 polyhydric alcohols, dimethyl sulfoxide, dimethylformamide, tetrahydrofuran and dioxane.

14. A magnetic disk that has undergone texturing using said composition according to any one of claims 1 to 11.

15. A magnetic disk that has undergone texturing using said slurry according to claim 12 or claim 13.
